(19) United States
(12) Patent Application Publication
(10) Pub. No.: US 2021/0381616 A1
(43) Pub. Date: Dec. 9, 2021

(54) SOLENOID VALVE DEVICE FOR A PRESSURE-COMPENSATED SOLENOID VALVE, PRESSURE-COMPENSATED SOLENOID VALVE, SOLENOID VALVE SYSTEM, AND METHOD USING THE SOLENOID VALVE DEVICE

(71) Applicant: ETO MAGNETIC GmbH, Stockach (DE)

(72) Inventor: Oliver THODE, Stockach (DE)

(21) Appl. No.: 17/290,460

(22) PCT Filed: Oct. 31, 2019
(86) PCT No.: PCT/EP2019/079908

§ 371 Date: Jul. 29, 2021

(30) Foreign Application Priority Data
Nov. 5, 2018 (DE) 10 2018 127 573.0

(51) Int. Cl. F16K 31/06; F16K 11/044; F16K 27/00

(52) U.S. Cl. CPC F16K 31/0627; F16K 27/0263; F16K 27/003; F16K 11/044

(57) ABSTRACT

A solenoid valve device for a pressure-compensated solenoid valve, in particular a pressure-compensating solenoid valve device, has a magnet part including at least one magnetic coil winding and preferably at least one magnetic core arranged at least partially in an interior of the magnetic coil winding, and has a valve part including at least one tappet unit, which is at least configured to control at least one flow-through path through the solenoid valve and which is at least configured to interact with a magnetic field generated within the magnet part, at least for a generation of at least one movement of the tappet unit, wherein the magnet part and the valve part form separable, independently functional modules which are in particular free of shared functional components, such as a shared magnet armature.

### PRIOR ART

The invention relates to a solenoid valve device for a pressure-compensated solenoid valve according to the preamble of claim 1, a pressure-compensated solenoid valve according to the preamble of claim 17, a solenoid valve system according to claim 18, and a method using the solenoid valve device according to claim 21.

There has already been proposed a solenoid valve device for a pressure-compensated solenoid valve with a magnet part, comprising at least one magnetic coil winding, and with a valve part, comprising at least one tappet unit which is at least configured to control at least one flow-through path through the solenoid valve and which is at least configured to interact with a magnetic field generated within the magnet part to at least generate at least one movement of the tappet unit.

The object of the invention is particularly to provide a device of the generic type with a particularly efficient use of magnetic force. The object is achieved according to the invention by the features of patent claims 1, 17, 18, and 21, while advantageous embodiments and developments of the invention can be found in the dependent claims.

### ADVANTAGES OF THE INVENTION

The invention starts from a solenoid valve device for a pressure-compensated solenoid valve, from an in particular pressure-compensating solenoid valve device with a magnet part, comprising at least one magnetic coil winding and preferably at least one magnetic core arranged at least partially in an interior of the magnetic coil winding, and with a valve part, comprising at least one tappet unit which is at least configured to control at least one flow-through path through the solenoid valve and which is at least configured to interact with a magnetic field generated within the magnet part at least for a generation of at least one movement of the tappet unit.

It is proposed that the magnet part and the valve part form separable, independently functional modules which are in particular free of shared functional components, such as a common magnet armature. A particularly efficient use of magnetic force can thereby advantageously be achieved, particularly in that a frictional force between components of the magnet part and components of the valve part can be reduced when the magnetic valve is switched. Advantageously, the valve part, particularly the tappet unit of the valve part, and the magnet part are largely decoupled from one another even in an assembled state, i.e., particularly decoupled from one another apart from a simple support of the valve part on the magnet part and/or apart from a simple, preferably planar, seat of the magnet part on the valve part. A simple assembly can advantageously be made possible, particularly in that only a simple connection of two modules is necessary to establish full functionality of the solenoid valve and complex alignment of the individual parts of the solenoid valve, for example, the magnetic coil winding and the tappet unit, can advantageously be eliminated. As a result, an assembly of the solenoid valve device, a conversion of the solenoid valve device can advantageously and/or an exchange of a magnet part or a valve part of the solenoid valve device outside the production facility, for example at a customer's site or in a workshop, can be made possible. A simple assembly of a solenoid valve can advantageously be made possible, for example in that different valve parts or different magnet parts can easily be combined with one another. This combinability can advantageously keep logistics costs low, for example the cost of storing a plurality of different valves or the cost of documenting a plurality of different valves, particularly in that not every possible combination, i.e., particularly not every possible solenoid valve must be documented and/or kept in stock, but only the individual magnet parts and valve parts, which allow a large number of combinations. In this way, costs can advantageously be kept low. Pressure-compensating solenoid valves are particularly advantageous since a pressure prevailing in the solenoid valve can be disregarded for establishing a balance of forces for the solenoid valve, and accordingly does not have to be taken into account particularly when designing magnetic forces. As a result, magnetic forces which are necessary for switching the solenoid valve can advantageously be kept low, as a result of which the size of the magnets used can advantageously be reduced. Thereby, particularly compact and/or particularly inexpensive solenoid valves can be obtained.

A “pressure-compensated solenoid valve” is to be understood particularly as a solenoid valve which is at least substantially free from pressure differences that are influencing valve movement and/or aggravating on different, particularly opposite, sides of the solenoid valve, particularly an armature of the solenoid valve. A “magnet part” is to be understood particularly as a module of the solenoid valve device which is configured to generate a magnetic field which, particularly, leads to a circuit and/or is configured for controlling a solenoid valve. A “valve part” is to be understood particularly as a module of the solenoid valve device which is configured for manipulating, particularly controlling and/or regulating, a flow or a path of a flow, for which purpose the valve part preferably has a movable valve seal which is configured to block and/or to open at least one path of the flow. The valve part and the magnet part can preferably be coupled to one another in a simple manner, particularly by means of coupling elements that correspond to one another. The coupling between the valve part and the magnet part is preferably releasable in a non-destructive manner. For example, the valve part and the magnet part can be coupled to one another by means of a form-fit connection, for example a clip connection, a screw-on connection, for example by means of an external thread of the magnet part, a snap fastener connection, a Velcro connection and/or the like. As an alternative or in addition, the valve part and the magnet part can be implemented such that they can be coupled to one another by means of a screwed connection, a rivet connection or the like. It is also conceivable that the coupling between the valve part and the magnet part is at least substantially pressure-tight. A “substantially pressure-tight” coupling is to be understood particularly as a coupling which is at least configured to withstand a pressure of at least 10 bar, preferably at least 20 bar, advantageously at least 30 bar, preferably at least 50 bar, and particularly preferably at least 80 bar.

A tappet unit is to be understood particularly as a unit which is configured to transmit and/or create an opening, closing and/or switching movement of the solenoid valve. The tappet unit comprises at least one armature tappet, which can be implemented in one piece or in several parts. For example, a magnet part-side part of the armature tappet can at least partially consist of a ferromagnetic and/or soft magnetic material, for example, an iron or an iron alloy, and a part of the armature plunger facing away from the magnet part can be formed at least partially from a sealing material, for example, an elastomer. Preferably, at least the part of the armature tappet on the magnet part side is configured to interact with the magnetic field of the magnet part. Particularly, the magnetic field of the magnet part is configured to pull the armature tappet in the direction of the magnet part. Particularly, the tappet unit is supported movably within the valve part. Particularly, at least the armature tappet is slidably mounted within the valve part. A “module” is to be understood particularly as a replaceable, particularly complex, element within an overall system, a device or a machine, preferably within a solenoid valve, which preferably forms a closed functional unit. Particularly, the modules, preferably at least the module formed by the valve part and the module formed by the magnet part, can be combined to form an overall system, preferably to form the solenoid valve. The modules, preferably at least the module formed by the valve part and the module formed by the magnet part, each have at least one interface, which are in particular configured to allow the modules to interact with one another, for example via the magnetic field of the magnet part. Particularly, the magnetic coil winding forms a solenoid. A “solenoid” is to be understood particularly as a cylindrical metal coil which acts similarly to a bar magnet when a current flows through it. “In one piece” is to be understood particularly as at least cohesively connected, for example by a welding process, an adhesive process, an injection molding process and/or another process that appears sensible to a person skilled in the art, and/or be understood as advantageously molded in one piece, such as by being manufactured from a cast and/or by being manufactured in a single or multi-component injection molding process and advantageously from a single blank. The magnetic core is designed particularly as an iron circuit, preferably interrupted at least in sections. Alternatively, the magnet part can also be implemented free from a magnetic core, particularly an iron circuit.

It is further proposed that the valve part is at least substantially free of, in particular movably supported, components, which at least partially engage in the magnet part in at least one operation state, in particular apart from components such as non-positive or positive engagements, which are configured exclusively for mutual fastening of the modules of the valve part and the magnet part. A particularly efficient use of magnetic force can thereby advantageously be achieved, particularly in that a frictional force between components of the magnet part and components of the valve part can be reduced when the magnetic valve is switched. Particularly, friction of at least part of the movably supported tappet unit with part of the magnet unit, for example a seal or a wall that guides the tappet unit within the magnet part, can thereby advantageously be avoided. This can advantageously reduce wear and prevent overheating of components of the solenoid valve, for example excessive heating of the valve part due to excessive heat transfer from the operationally hot magnetic coil winding of the magnet part to the valve part and/or a magnetic force necessary for a movement of the tappet unit can be kept low. Complexity, particularly manufacturing outlay for the solenoid valve, can advantageously be kept low by advantageously eliminating a fitting into and/or adjustment to a component of the valve unit, for example, a magnet armature, which at least partially engages in the magnet part in at least the operation state, into an opening of the magnet part, particularly into the interior of a coil winding of the magnet part. As a result, it is advantageously possible to eliminate a complex setting of alignment tolerances between the magnet part and the valve part, whereby particularly advantageously additional frictional forces generated by inaccurate alignment and/or misalignments. Since fewer additional frictional forces counteract a movement of the tappet unit, the magnetic forces necessary for the movement of the tappet unit can advantageously be reduced, whereby particularly the costs for the coil winding and/or the space required for the coil winding can be reduced. In addition, assembly of the solenoid valve device, conversion of the solenoid valve device, and/or replacement of a magnet part and/or of a valve part can advantageously be simplified, particularly in that no precise setting of alignment tolerances is necessary. Assembly of the solenoid valve device and conversion of the solenoid valve device, and/or replacement of the magnet part and/or of the valve part can be performed to an exact alignment, whether special tools are used or not. The fact that a structural unit of a device is “essentially free” of components engaging in another structural unit of the device is to be understood particularly to mean that the structural unit is free of components responsible for a main function, particularly for a valve switching function, which engage in another structural unit. “Partially engaging” should be understood to mean particularly at least 15% of a total volume, preferably at least 10% of a total volume, preferably at least 5% of a total volume, and particularly preferably at least 2% of a total volume.

It is also proposed that the magnet part is at least essentially free of movably supported components and/or of components which at least partially engage in the valve part in at least one operation state. A particularly efficient use of magnetic force can thereby advantageously be achieved, particularly in that a frictional force between components of the magnet part and components of the valve part can be reduced when the magnetic valve is switched. This can advantageously reduce wear and prevent overheating of components of the solenoid valve, for example, excessive heating up of the valve part due to excessive heat transfer from the operationally hot magnetic coil winding of the magnet part to the valve part and/or a magnetic force necessary for a movement of the tappet unit can be kept low. In addition, the complexity, particularly the manufacturing outlay, particularly for the magnet part, can advantageously be kept low.

It is also proposed that the valve part and/or the magnet part have/has a sealing and assembly device, which is configured to produce an, in particular pressure-tight, coupling of the module formed by the valve part and the module formed by the magnet part. This allows particularly advantageous and/or simple assembly of the solenoid valve device. The sealing and assembly device comprises particularly at least one coupling element, preferably the corresponding coupling elements. The sealing and assembly device comprises particularly at least one sealing element, for example a plastic seal, such as an (elastomeric) O-ring and/or a metal seal, such as a copper sealing ring. The sealing and assembly device is in particular configured to seal an interior of the solenoid valve, particularly the flow-through path of the solenoid valve, from an exterior surrounding the solenoid valve. Alternatively or additionally, the sealing and assembly device can be configured to seal the magnet part with respect to the valve part, particularly with respect to cavities arranged in the valve part for a fluid guide or receptacle, or vice versa. The term “configured” is to be understood particularly as specifically programmed, designed, and/or equipped. The fact that an object is configured for a specific function should be understood particularly as that the object can fulfill and/or perform this specific function in at least one application and/or operating condition.

If the module, which is coupled to the valve part and formed by the magnet part, can be decoupled from the valve part in a non-destructive manner, simple replacement, simple conversion, and/or a simple repair of the solenoid valve device can advantageously be performed, whereby costs can advantageously be kept low. In addition, a high degree of flexibility can advantageously be achieved in this way, for example in that a solenoid valve device can be easily adjusted to changed operating conditions through a conversion, e.g. a magnet part with a stronger magnet or with a different power connection or a valve part with a different valve circuit or a different flow capacity can be installed. The solenoid valve device can advantageously be decoupled in a non-destructive manner when it is installed in a device, for example, in a vehicle. The fact that the “module formed by the magnet part can be decoupled from the valve part in a non-destructive manner” should be understood particularly as that at least the magnet part or the valve part, preferably the magnet part and the valve part, survive a decoupling process without being destroyed, wherein particularly full functionality of the modules of the valve part and/or of the magnet part is retained even after the decoupling process.

It is also proposed that, in particular at least on a side of the tappet unit facing the magnet part in an assembled state, the tappet unit at least partially forms a flat armature, preferably the armature tappet of the tappet unit. As a result, advantageous interaction properties between the magnetic field of the magnet part and the valve part, particularly the tappet unit, can be achieved. A particularly effective transmission of a magnetic force can advantageously be achieved. A coupling of the magnetic field of the magnet part with a ferromagnetic component of the armature tappet of the tappet unit can advantageously be optimized when the solenoid valve device is ready for operation. A high magnetic force can advantageously be achieved through the flat armature. Particularly when using the solenoid valve device in a vehicle which has ambient temperatures between −40° C. and +80° C., particularly up to 130° C., the use of sliding seals potentially results in a significant temperature-dependent friction hysteresis, which can advantageously be overcome by means of the considerably increased magnetic force due to the use of a flat armature. A “flat armature” is to be understood particularly as an armature tappet which forms a flattened area, particularly a type of disc, on at least one end, particularly pointing in an intended direction of movement of the armature tappet. Particularly, the flattened area of the armature tappet, particularly the disc, has a diameter perpendicular to an axis of movement of the armature tappet which is significantly larger than a diameter of the magnet core which is intended to interact with the armature tappet and/or is much larger than a diameter of the interior of the magnet coil winding. Particularly, the flattened area of the armature tappet, particularly the disc, has a diameter perpendicular to an axis of movement of the armature tappet which is significantly larger than a mean diameter of the tappet unit perpendicular to the axis of movement of the armature tappet. “Much larger” is to be understood as at least 10% larger, preferably at least around 20%, preferably at least 30% larger, and particularly preferably at least 100% larger.

In addition, it is proposed that the tappet unit has at least one pressure compensation element, which is configured particularly to compensate a pressure on a side of the tappet unit facing the magnet part and a pressure on a side of the tappet unit facing away from the magnet part. As a result, an equalized pressure balance within the solenoid valve device can advantageously be achieved when the tappet unit is in operation. Particularly, a pressure difference on different sides of the tappet unit can advantageously be neglected when determining the balance of forces of the solenoid valve. As a result, a low magnetic force is advantageously required for proper operation of the tappet unit. As a result, a magnet coil winding can advantageously be designed to be particularly small, whereby costs and installation space can advantageously be reduced. The pressure compensation element is implemented particularly as a continuous recess, particularly as a continuous bore, through the tappet unit, particularly the armature tappet, which is preferably at least substantially parallel to a longitudinal direction of the tappet unit and/or extends to an intended direction of movement of the tappet unit. “Substantially parallel” should be understood here, particularly, as an alignment of a direction relative to a reference direction, particularly in a plane, wherein the direction has a deviation from the reference direction, particularly less than 8°, advantageously less than 5°, and particularly advantageously less than 2°. Particularly, it is conceivable that the tappet unit has more than one pressure compensation element. Particularly, the pressure compensation element is configured to connect a pressure port of the valve part to at least one further cavity of the valve part which, apart from the pressure compensation element, is sealed off from the pressure port and/or from all other ports of the valve part. The pressure port is particularly configured to connect the solenoid valve device to a pressure line. It is conceivable that a plurality of, for example, interlinked solenoid valve devices are connected to an identical pressure line.

It is also proposed that the tappet unit has at least one restoring element, which is supported against the magnet part, in particular against the magnetic core of the magnet part, and/or against a magnet part housing surrounding the magnet part. This advantageously enables effective valve switching of the solenoid valve. In addition, a currentless switching state of the solenoid valve can advantageously be generated. Furthermore, a compact design of the solenoid valve device can be achieved by direct support against the magnet part. The restoring element is particularly configured to put the tappet unit into a state of rest after the magnetic field of the magnet unit has been switched off and/or to deflect back an initial state. The restoring element is particularly configured to generate a restoring force which acts against a force generated by the magnet coil winding and acting in an attractive manner on the tappet unit. In addition, the restoring element is configured to prevent magnetic adhesion of the tappet unit to the magnet part, for example, by at least partial magnetization of the tappet unit. It is conceivable that the solenoid valve device comprises a plurality of restoring elements. The restoring element is particularly embodied as a spring, preferably a spiral spring, and particularly preferably a compression spring. Particularly, the restoring element makes direct contact with the magnet part. Alternatively, it is conceivable that the restoring element is supported indirectly on the magnet part, for example by means of an inserted force transmission element.

It is further proposed that the restoring element is arranged at least partially within the pressure compensation element. This advantageously results in a particularly compact design. In addition, an effective and evenly distributed force transmission can advantageously take place between the restoring element and the tappet unit. Particularly, the pressure compensation element is supported against at least one shoulder and/or against at least one projection within the pressure compensation element. Particularly, the pressure compensation element has a section with an enlarged cross section, within which the restoring element is inserted. Alternatively, the pressure compensation element could have a constant cross section or a cross section that becomes smaller on the magnet-part side of the tappet unit, wherein inwardly directed projections are arranged along a circumference by means of which the restoring element is supported against the tappet unit.

It is also proposed that the magnet part and the valve part are at least substantially thermally decoupled from one another. As a result, the formation of a frictional force hysteresis, particularly a temperature-dependent frictional force hysteresis, can advantageously be reduced or preferably be prevented. Particularly, it can advantageously be prevented that magnet heating due to operation of the magnet coil winding is transmitted directly, particularly via contact heat conduction, to a seal, particularly to a sliding seal, of the magnet valve device. As a result, a frictional resistance can advantageously be kept low, as a result of which a maximum required magnetic force can be kept low and as a result of which a reduced structural size and reduced costs can advantageously be achieved. The fact that two components are “substantially thermally decoupled from one another” is to be understood particularly as meaning that a thermal radiation and/or a fluid is responsible for a heat flow between the two components, at least substantially, particularly at least for 66%, preferably at least for 75%, and particularly preferably at least for 90%.

It is also proposed that the valve part comprises at least one housing with at least one pressure port, at least one working port and/or at least one venting port, wherein the pressure port is sealed against the working port and/or the venting port at least by means of a sealing arrangement. In particular, an advantageous valve configuration can thereby be achieved. The housing is in particular implemented as a turned part, particularly as a turned metal part, as an injection-molded part, particularly a injection molded plastic part, or as a 3D printed part. Particularly, the pressure port is sealed off from the working port in at least one position of the tappet unit in the valve part. Particularly, the pressure port is sealed off from the venting port in at least one position of the tappet unit in the valve part. The sealing arrangement is in particular configured to connect the housing and the tappet unit in a pressure-tight manner. The sealing arrangement is in particular configured to maintain a seal between the tappet unit and the housing when the tappet unit moves. Particularly, the sealing arrangement comprises a sliding seal. The sliding seal is implemented particularly as a greased O-ring or as a specially coated elastomer. Alternatively, the sealing arrangement is implemented as a hard-sealing sealing arrangement. Alternatively, the sealing arrangement comprises at least one, particularly pressure-tight, bellows and/or at least one membrane seal.

It is also proposed that at least one seal, in particular the sliding seal, of the sealing arrangement has a sealing diameter which at least substantially corresponds to an effective diameter of at least one valve seat of the valve part, preferably of all valve seats of the valve part. As a result, a pressure-compensating configuration of the valve part can advantageously be achieved. Particularly, a pressure gradient between a pressure applied to the valve seat and a pressure applied to the seal of the sealing arrangement can thereby advantageously be reduced to a value close to zero. A “seal diameter” is to be understood particularly as a diameter, preferably an inside diameter, of the sliding seal, particularly of the sealing ring, which seals the housing against the tappet unit. An “effective diameter” is to be understood particularly as a minimum diameter of an opening of a valve seat. Particularly, the seal of the sealing arrangement and the opening of the valve seat are at least substantially round. All valve seats of the valve part preferably have at least substantially identical effective diameters. The fact that two parameters “substantially match” is to be understood particularly as meaning that the two parameters have a difference which is less than 5%, is preferably less than 3% and particularly preferably less than 1% of an absolute value of one of the parameters.

If the sealing arrangement comprises at least one sliding seal, good sealing properties can advantageously be achieved while costs can be kept moderate.

Furthermore, it is proposed that the sliding seal comprises a sealing ring, which is at least largely formed from an elastomer, wherein the elastomer comprises a thin layer of polytetrafluoroethylene (Teflon), particularly at a layer thickness of less than 0.5 mm, preferably less than 0.25 mm. As a result, a solenoid valve device can advantageously be created for a pressure-compensated solenoid valve which is particularly wear-resistant and/or includes a particularly low-friction and yet high-sealing sliding seal. As a result, a long service life can advantageously be achieved. A frictional force of the seal can advantageously be reduced by 80%. In addition, a friction hysteresis can advantageously be reduced. Furthermore, a substantially temperature-independent friction hysteresis can advantageously be achieved. The elastomer is preferably formed as a rubber, particularly a hydrogenated acrylonitrile butadiene rubber or as a fluororubber. Particularly, the sealing ring is designed as a groove ring with a preferably V-shaped recess which is open in the direction of an axis of symmetry of the groove ring and which runs around the groove ring.

It is also proposed that at least the magnet part is hermetically enclosed by injection-molding. This advantageously allows shielding the magnet part from contamination, particularly from potentially corrosive pressure fluid which is conducted in the fluid lines of the valve part, particularly also in the pressure compensation element. As a result, a long service life can advantageously be achieved. In addition, simple cleaning of a dismantled magnet part can advantageously be made possible. Particularly, the hermetic encapsulation forms a completely closed magnet part housing surrounding the magnet part. Particularly, the magnet part is hermetically encapsulated by means of a plastic. The expression “hermetically encapsulated” is to be understood as particularly fully encapsulated and at least encapsulated in a sealing manner against dirt particles, preferably against liquids. Particularly, this advantageously enables the magnet part to be used under humid ambient conditions, for example in an outside area, for example the engine area, of a vehicle. The hermetic encapsulation has a thickness of at least 1 mm, preferably at least 3 mm, preferably at least 5 mm and particularly preferably at most 20/mm.

It is also proposed that the tappet unit has the at least one first valve seal and at least one second valve seal, which is in particular spaced apart from the first valve seal along an axis of movement of the tappet unit, in particular of an armature tappet of the tappet unit, and/or is preferably realized separately from the first valve seal, wherein the valve seals are configured to block and/or open respectively different flow-through paths through the solenoid valve. A simple assembly can thereby advantageously be made possible, particularly in that an additional sliding seal can be eliminated. A long service life can advantageously be achieved and/or wear can be reduced. Particularly, the valve seals are arranged at different positions along the axis of movement of the tappet unit, particularly the armature tappet of the tappet unit. Particularly, a distance between the valve seals along the axis of movement corresponds to at least a distance between the two valve seats which are most distant from one another and which can all be closed and/or opened by the tappet unit of the solenoid valve unit. Particularly, none of the valve ports of the solenoid valve unit, particularly not the pressure port, not the working port, and/or not the venting port, can be closed at the same time by the first valve seal and the second valve seal.

In addition, a pressure-compensated solenoid valve is proposed with the solenoid valve device, wherein the solenoid valve is implemented as 3/2 NO—(“normally open”) valve, as a 3/2 NC (“normally closed”) valve, as a 2/2 NO valve or as a 2/2 NC valve. In particular, a valve having advantageous valve properties can thereby be achieved. In particular, the valve part of the solenoid valve can be changed as desired to either obtain a 3/2 NO valve, a 3/2 NC valve, a 2/2 NO valve or a 2/2 NC valve, especially if a respective rearrangement of the solenoid valve ports of the solenoid valve is made when changing the valve part. As a result, a high flexibility can advantageously be achieved.

In addition, a solenoid valve system with a solenoid valve device is proposed, wherein the solenoid valve system has a plurality of magnet parts that are at least partially implemented differently from one another, can be interchangeably coupled to the valve part and are implemented as a separable module, wherein the magnet parts particularly have different magnetic coil windings and/or different electrical connection devices and/or have electrical control devices and/or wherein the solenoid valve system has a plurality of valve parts that are at least partially implemented differently from one another, can be interchangeably coupled to the magnet part and are implemented as a separable module, wherein the valve parts in particular have different housings with different feed and discharge lines. A particularly efficient use of magnetic force can thereby advantageously be achieved, particularly in that an exact coordination and/or design of a solenoid valve for a specific system can be achieved by means of an appropriate selection of modules combined with one another. As a result, a high flexibility can advantageously be achieved as well. Particularly, the magnet parts have different connection devices which, for example, have different connector systems or connector variants and/or are adapted for different voltage sources. Particularly, the valve parts have different flow-through paths, which differ, for example, in their cross section, particularly in their maximum possible flow rate, in the number of ports, particularly inlets and/or outlets, and/or in the manner of the currentless zero position (NO/NC). For example, the solenoid valve system includes valve parts which configured to form 3/2-NO solenoid valves, 3/2-NC solenoid valves, 2/2-NO solenoid valves, or 2/2-NC solenoid valves, in particular in each case with several possible dimensionings of the flow-through rates.

In addition, the magnet part of the solenoid valve device and the valve part of the solenoid valve device are proposed.

Furthermore, a method with a solenoid valve device for a pressure-compensated solenoid valve, with a solenoid valve and/or with a solenoid valve system is proposed. A particularly efficient use of magnetic force can thereby advantageously be achieved.

The solenoid valve device according to the invention for a pressure-compensated solenoid valve, the pressure-compensated solenoid valve according to the invention, the solenoid valve system according to the invention, and/or the method according to the invention with the solenoid valve device should herein not be restricted to the application and implementation described above. In particular, in order to fulfill a functionality that is mentioned here, the solenoid valve device according to the invention for a pressure-compensated solenoid valve, the pressure-compensated solenoid valve according to the invention, the solenoid valve system according to the invention, and/or the method according to the invention with the solenoid valve device may comprise a number of individual elements, components, and units that differs from the number mentioned herein.

### DRAWINGS

Further advantages can be derived from the following description of the drawings. Three exemplary embodiments of the invention are shown in the drawings. The drawings, the description, and the claims contain numerous features in combination. A person skilled in the art will expediently also consider the features individually and combine them into meaningful other combinations.

Wherein:

FIG. 1 a schematic sectional view of a solenoid valve with a solenoid valve device,

FIG. 2 a schematic sectional view of a sealing ring of a sliding seal of the solenoid valve device,

FIG. 3 a schematic representation of a solenoid valve system to form various solenoid valves,

FIG. 4 a flowchart of a method with the solenoid valve,

FIG. 5 a schematic sectional view of an alternative solenoid valve with an alternative solenoid valve device, and

FIG. 6 a schematic sectional view of a solenoid valve with another alternative solenoid valve device.

### DESCRIPTION OF THE EXEMPLARY EMBODIMENTS

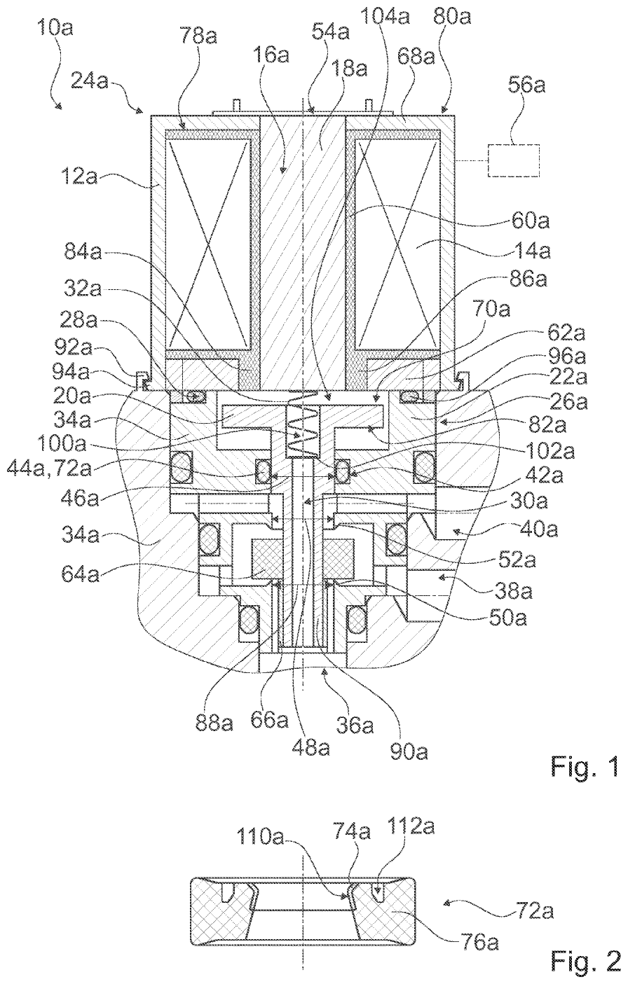

FIG. 1 shows a solenoid valve 10a. The solenoid valve 10a is in a currentless state. The solenoid valve 10a is realized as a pressure-compensating solenoid valve. The solenoid valve 10a is realized as a 3/2-way valve, The solenoid valve 10a has a pressure-compensating solenoid valve device. The solenoid valve device has a magnet part 12a. The magnet part 12a is configured to generate and/or control a magnetic field. The magnet part 12a forms an independently functioning module 24a. The magnet part 12a is free of movably supported components.

The magnet part 12a has a magnetic coil winding 14a. The magnetic coil winding 14a is embodied as a magnetic coil winding. Particularly, the magnetic coil 14a winding forms a solenoid 78a. The magnetic coil winding 14a forms an electromagnetic coil. The magnet part 12a comprises a winding carrier 60a. The winding carrier 60a is made of a non-conductive one and/or non-magnetizable plastic. The magnetic coil winding 14a is wound around the winding carrier 60a. The magnetic coil winding 14a and/or the solenoid 78a includes an interior 16a. The interior 16a of the magnetic coil winding 14a comprises a magnetic core 18a. The magnetic core 18a forms a partially interrupted iron circuit. The magnetic core 18a is arranged at least in a center of the solenoid 78a. Alternatively, the interior 16a of the magnetic coil winding 14a and/or the entire magnet part 12a can be formed free of a magnetic core 18a. The magnet part 12a comprises a magnetic circuit 80a. The magnetic circuit 80a is at least partially made of a ferromagnetic and/or a soft magnetic material, particularly of iron. The magnetic circuit 18a includes the magnetic core 80a. The magnetic circuit 80a includes a magnet bracket 68a. The magnet bracket 68a at least partially encloses the magnetic coil winding 14a. The magnetic circuit 80a, particularly the magnet bracket 68a, can alternatively or additionally be at least partially realized as a round magnet housing. The magnetic circuit 80a includes a magnet yoke 62a. The magnet yoke 62a at least partially encloses the magnetic coil winding 14a. The components 18a, 62a, 68a of the magnetic circuit 80a are implemented as separate elements.

Alternatively, the components 18a, 62a, 68a of the magnetic circuit 80a could be integral with one another. The magnetic circuit 80a is realized as an open magnetic circuit. The magnetic circuit 80a comprises a gap 84a. The magnetic circuit 80a comprises a further gap 86a. The gap 84a of the magnetic circuit 80a is at least partially filled by the winding carrier 60a. The further gap 86a of the magnetic circuit 80a is at least partially filled by the winding carrier 60a. The gaps 84a, 86a, in combination with the iron circuit of the magnetic circuit 80a, produces an inductance of the magnetic circuit 80a. The magnet part 12a has a connection device 54a. The connection device 54a forms a plug connection. The connection device 54a is configured for an electrical connection of the magnet coil winding 14a.

The solenoid valve device has a control device 56a. The control device 56a is configured for controlling a power supply to the magnet part 12a. The control device 56a is configured for controlling a magnetic field of the magnetic coil winding 14a. The control device 56a is configured for controlling the solenoid valve 10a by means of the magnetic coil winding 14a.

The solenoid valve device has a valve part 22a. The valve part 22a forms an independently functioning module 26a. The valve part 22a has a tappet unit 20a. The tappet unit 20a is configured to control a flow-through path through the solenoid valve 10a. The tappet unit 20a is configured to interact with a magnetic field generated within the magnet part 12a. The interaction of the tappet unit 20a with the magnetic field of the magnet part 12a is intended to generate a movement of the tappet unit 20. The tappet unit 20a is configured to move towards the magnet part 12a when the magnetic field is activated. The tappet unit 20a is configured to minimize the inductance of the magnetic circuit 80a by means of a movement in the direction of the gaps 84a, 86a of the magnetic circuit 80a of the magnet part 12a. When the magnetic field of the magnet part 12a is activated, the tappet unit 20a is pulled by the magnetic field in the direction of the gaps 84a, 86a.

The valve part 22a has a housing 34a. The housing 34a forms a valve housing. The tappet unit 20a is movably supported in the housing 34a. The housing 34a is constructed in multiple parts. Separately formed sub-units of the housing 34a are sealed pressure-tight. Alternatively, the housing 34 could be formed in one piece. The valve part 22a comprises a guide element 66a. The guide element 66a is configured for guiding the tappet unit 20a within the valve part 22a. The housing 34a has a pressure port 36a. The pressure port 36a is implemented as a housing opening. The pressure port 36a is arranged on a side of the mounted magnetic valve device facing away from the magnet part 12a. The housing 34a has a working port 38a. The working port 38a is implemented as a housing opening. The housing 34a has a venting port 40a. The venting port 40a is implemented as a housing opening. The valve part 22a has a sealing arrangement 42a. The pressure port 36a is sealed off from the working port 38a by means of the sealing arrangement 42a. The pressure port 36a is sealed off from the venting port 40a by means of the sealing arrangement 42a. The sealing arrangement 42a has a seal 44a. The seal 44a of the sealing arrangement 42a is embodied as a sliding seal 72a. The seal 44a of the sealing arrangement 42a has a seal diameter 46a.

The solenoid valve device has a valve seal 64a. The valve seal 64a is configured to close or open specific flow-through paths. The valve part 22a has a first valve seat 50a. The valve seal 64a is configured to be seated in a sealing manner on the first valve seat 50a. When the valve seal 64a sits tightly on the first valve seat 50a, the pressure port 36a is closed. When the valve seal 64a is seated in a sealing manner on the first valve seat 50a, a path between the working port 38a and the venting port 40a is opened. The first valve seat 50a has an effective diameter 48a. The effective diameter 48a of the first valve seat 50a corresponds at least substantially to the seal diameter 46a of the seal 44a of the seal arrangement 42a.

The valve part 22a has a second valve seat 52a. When the valve seal 64a sits sealingly on the second valve seat 52a, the venting port 40a is closed. When the valve seal 64a is seated in a sealing manner on the second valve seat 52a, a path between the working port 38a and the pressure port 36a is open. In the implementation of the solenoid valve 10a shown in FIG. 1, the first valve seat 50a is occupied in the currentless state. In the implementation of the solenoid valve 10a shown in FIG. 1, the second valve seat 52a is occupied in the currentless state. The second valve seat 52a has an effective diameter 88a. The effective diameter 88a of the second valve seat 52a corresponds at least substantially to the effective diameter 48a of the first valve seat 50a. The effective diameter 88a of the second valve seat 52a corresponds at least substantially to the seal diameter 46a of the seal 44a of the seal arrangement 42a.

In the implementation shown in FIG. 1, the solenoid valve 10a forms a 3/2-NC solenoid valve. Alternatively, the solenoid valve 10a could form a 3/2-NO solenoid valve if the pressure port 36a and the venting port 40a were interchanged. Alternatively, the solenoid valve 10a could form a 2/2-NC solenoid valve if the venting port 40a is closed. Alternatively, the solenoid valve 10a could form a 2/2-NO solenoid valve if the pressure port 36a is closed and if the working port 38a and the venting port 40a are interchanged and/or if the venting port 40a is closed.

The tappet unit 20a comprises an armature tappet 90a. The armature tappet 90a is formed of a ferromagnetic and/or a soft magnetic material. The armature tappet 90a is formed in one piece. Alternatively, the armature tappet 90a could be formed in multiple parts. The tappet unit 20a comprises the valve seal 64a. The valve seal 64a is pressed onto the armature tappet 90a. The tappet unit 20a forms a flat anchor 70a. The anchor tappet 90a forms the flat anchor 70a. The flat anchor 70a has a disc-shaped end region 82a. The disc-shaped end region 82a is arranged on a side of the armature tappet 90a facing the magnet part 12a. The disc-shaped end region 82a is arranged in a vicinity of the gaps 84a, 86a of the magnetic circuit 80a of the magnet part 12a. Due to the inductance of the gaps 84a, 86a, the disc-shaped end region 82a of the armature tappet 90a is drawn in the direction of the magnet part 12a when the magnet coil winding 14a is energized.

The tappet unit 20a has a pressure compensation element 30a. The pressure compensation element 30a is realized as a bore in the center of the tappet unit 20a, particularly the armature tappet 90a. The pressure compensation element 30a is configured to set an at least substantially identical pressure on the side of the tappet unit 20a facing the magnet part 12a as on the side facing the pressure port 36a.

The tappet unit 20a comprises a restoring element 32a. The restoring element 32a is embodied as a compression spring. The restoring element 32a is supported against the magnet part 12a. The restoring element 32a is directly supported against the magnetic core 18a of the magnet part 12a. The restoring element 32a is configured to push the tappet unit 20a away from the magnet part 12a. It is further proposed that the restoring element 32a is partially arranged within the pressure compensation element 30a. The pressure compensation element 30a comprises a receiving area 100a. The receiving area 100a of the pressure compensation element 30a is implemented as a widened section of the pressure compensation element 30a. The receiving area 100a of the pressure compensation element 30a forms a shoulder 102a. The restoring element 32a is supported against the shoulder 102a of the pressure compensation element 30a.

The magnet part 12a and the valve part 22a form separable modules 24a, 26a. The magnet part 12a and the valve part 22a form independently functional modules 24a, 26a. The modules 24a, 26a formed by the magnet part 12a and the valve part 22a are free of shared functional components. The valve part 22a is at least substantially free of components which at least partially engage in the magnet part 12a in at least one operation state. The magnet part 12a is at least substantially free of components which at least partially engage in the valve part 22a in at least one operation state.

The magnet part 12a and the valve part 22a can be coupled to one another. The magnet part 12a and the valve part 22a can be captively coupled to one another. In the implementation shown in FIG. 1, the magnet part 12a is coupled to the valve part 22a, particularly captively. The module 24a, which is coupled to the valve part 22a and formed by the magnet part 12a, can be decoupled from the valve part 22a in a non-destructive manner. The magnet part 12a and the valve part 22a are at least substantially thermally decoupled from one another. The magnet part 12a and the valve part 22a, when coupled to one another, are at least substantially thermally decoupled from one another. The valve part 22a comprises a sealing and assembly device 28a. The magnet part 12a comprises a sealing and assembly device 28a. The sealing and assembly device 28a is configured to produce a coupling between the module 26a formed by the valve part 22a and the module 24a formed by the magnet part 12a. The sealing and assembly device 28a comprises respective coupling elements 92a, 94a. A coupling element 92a of the sealing and assembly device 28a is associated with the valve part 22a. Another coupling element 94a is associated with the magnet part 12a. The respective coupling elements 92a, 94a form a positive connection. The sealing and assembly device 28a forms a detachable, captive, and tight coupling of the magnet part 12a to the valve part 22a. The sealing and assembly device 28a comprises a sealing element 96a. The sealing element 96a is configured to produce a pressure-tight coupling between the magnet part 12a and the valve part 22a. The sealing element 96a is configured to seal a cavity 104a of the valve part 22a, which cavity is connected to the pressure port 36a via the pressure compensation element 30a, in a pressure-tight manner against the magnet part 12a.

FIG. 2 shows a schematic section through a sealing ring 76a of the sliding seal 72a. The sliding seal 72a includes the sealing ring 76a. The sealing ring 76a is formed from an elastomer. The sealing ring 76a has a surface coating 110a. The surface coating 110a forms a thin layer 74a. The thin layer 74a is formed from a polytetrafluoroethylene. The thin layer 74a is configured to reduce a surface friction of the sliding seal 72a. The thin layer 74a is configured to increase the resistance to wear of the sliding seal 72a. The sealing ring 76a comprises a V-shaped groove 112a. The groove 112a is configured to advantageously improve dynamic properties of the sealing ring 76a when the tappet unit 20a moves.

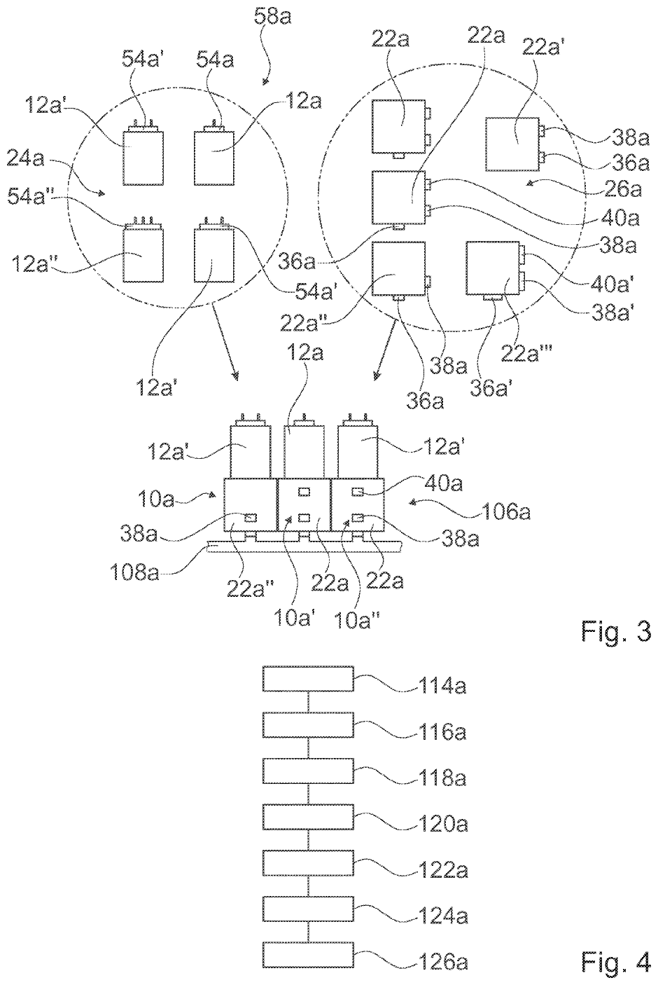

FIG. 3 shows a solenoid valve system 58a with the solenoid valve device. The solenoid valve system 58a forms a modular system, particularly a modular solenoid valve system. The solenoid valve system 58a comprises a plurality of solenoid parts 12a, 12a′, 12a″, each of which forming independent modules 24a. The magnet parts 12a, 12a′, 12a″ of the solenoid valve system 58a are implemented differently from one another. The magnet parts 12a, 12a′, 12a″ which are implemented differently from one another comprise different connection devices 54a, 54a′, 54a″. At least a portion of the magnet parts 12a, 12a′, 12a″ of the solenoid valve system 58a is identical. The solenoid valve system 58a comprises a plurality of valve parts 22a, 22a′, 22a″, 22a′″, each of which forming independent modules 26a. The valve parts 22a, 22a′, 22a″, 22a′″ of the solenoid valve system 58a are implemented differently from one another. The valve parts 22a, 22a′, 22a″, 22a′″, which are implemented differently from one another have different arrangements and/or dimensions of working ports 38a, 38a′, pressure ports 36a, 36a′, and/or venting ports 40a, 40a′. At least a portion of the valve parts 22a, 22a′, 22a″, 22a′″ of the solenoid valve system 58a is identical. The magnet parts 12a, 12a′, 12a″ of the solenoid valve system 58a can be interchangeably coupled to the valve parts 22a, 22a′, 22a″, 22a′″. Any magnet parts 12a, 12a′, 12a″ of the solenoid valve system 58a can be interchangeably coupled to any valve parts 22a, 22a′, 22a″, 22a′″. One magnet part 12a, 12a′, 12a″ and one valve part 22a, 22a′, 22a″, 22a′″ coupled to the magnet part 12a, 12a′, 12a″, respectively, form a solenoid valve 10a, 10a′, 10a″. The valve parts 22a, 22a′, 22a″, 22a′″ and the magnet parts 12a, 12a′, 12a″ of the solenoid valves 10a, 10a′, 10a″ can be decoupled non-destructively and/or are replaceable. Solenoid valves 10a, 10a′, 10a″ can be coupled to one another to form a valve chain 106a. The pressure ports 36a of the solenoid valves 10a of the valve chain 106a shown by way of example in FIG. 3 are connected to a shared pressure line 108a.

FIG. 4 shows a flow chart of a method with the solenoid valve device for the pressure-compensated solenoid valve 10a. In at least one method step 114a, a magnet part 12a and a valve part 22a are selected for coupling to a solenoid valve 10a. In at least one further method step 116a, the selected magnet part 12a is connected to the selected valve part 22a by means of the sealing and assembly device 28a. The connection produced in method step 116a between the magnet part 12a and the valve part 22a can be released. The connection produced in method step 116a between the magnet part 12a and the valve part 22a is pressure-tight. The connection produced in method step 116a between the magnet part 12a and the valve part 22a captively connects the magnet part 12a and the valve part 22a to one another. When the magnet part 12a and the valve part 22a are connected to one another, the respective coupling elements 92a, 94a are brought into positive engagement with one another. In at least one further method step 118a, the tappet unit 20a of the coupled valve part 22a is moved to a circuit of the solenoid valve 10a by a magnetic field generated by the magnetic coil winding 14a of the magnet part 12a. In method step 118a, the tappet unit 20a is pulled by the magnetic field in the direction of the magnet part 12a. In at least one further method step 120a, the tappet unit 20a is deflected back by the restoring element 32a. In method step 120a, the tappet unit 20a is pushed away from the magnet part 12a by the restoring element 32a. In at least one further method step 122a, the magnet part 12a is decoupled from the valve part 22a in a non-destructive manner. In at least one further method step 124a, the magnet part 12a is replaced for another magnet part 12a, 12a′, 12a″ which is different from the magnet part 12a and/or the valve part 22a is replaced by another valve part 22a, 22a′, 22a″, 22a′″ which is different from the valve part 22a. In at least one further method step 126a, the replaced other magnet part 12a, 12a′, 12a″ is coupled to the remaining valve part 22a and/or the replaced other valve part 22a, 22a′, 22a″, 22a′″ is coupled to the remaining magnet part 12a.

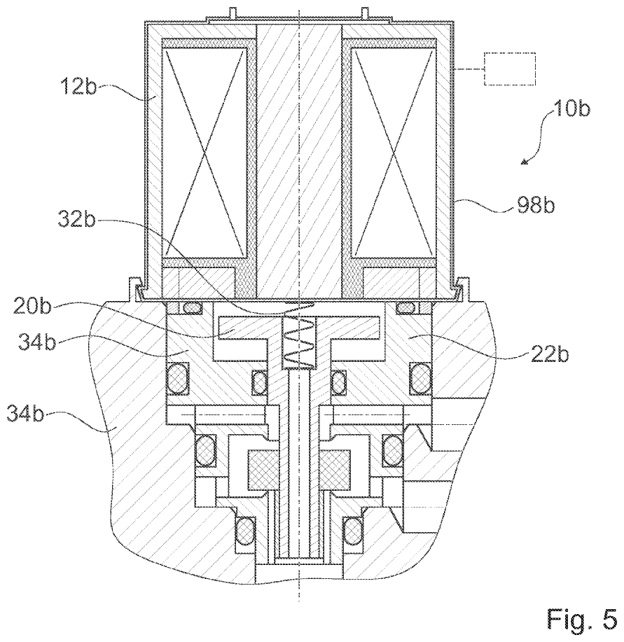

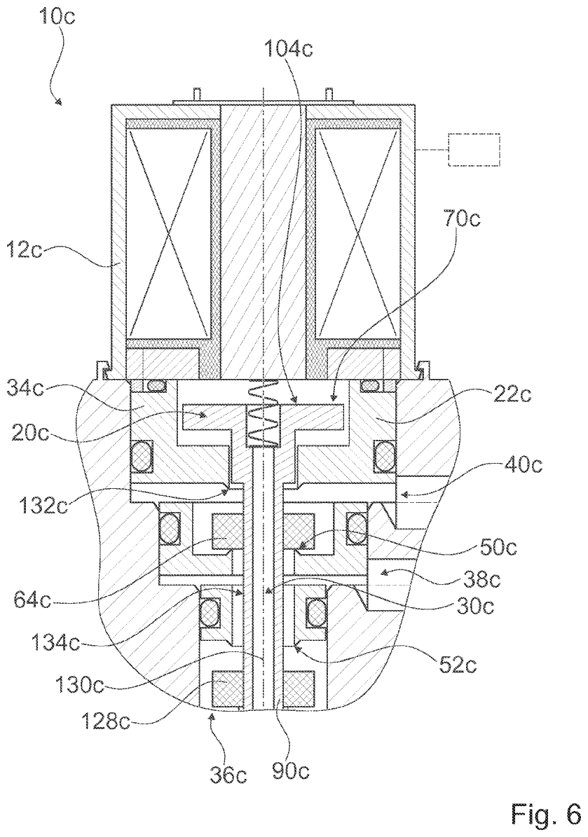

FIGS. 5 and 6 show two other exemplary embodiments of the invention. The following descriptions and the drawings are substantially limited to the differences between the exemplary embodiments, wherein the drawings and/or the description of the other exemplary embodiments, particularly those of FIGS. 1 to 4, can be referenced with respect to components having the same designation, particularly with components to components with the same reference numerals. To distinguish between the exemplary embodiments, the letter a is placed after the reference numerals of the exemplary embodiment in FIGS. 1 to 4. In the exemplary embodiments of FIGS. 5 and 6, the letter a is replaced by the letters b and c.

FIG. 5 shows an alternative solenoid valve 10b with an alternative solenoid valve device. The solenoid valve device comprises a magnet part 12b and a valve part 22b. The magnet part 12b is hermetically encapsulated. The magnet part 12b comprises a magnet part housing 98b. The hermetic encapsulation of the magnet part 12b forms the magnet part housing 98b. The magnet part housing 98b is configured to shield the magnet part 12b from external influences, for example, dirt or moisture. The valve part 22b comprises a housing 34b. The housing 34b of the valve part 22b and the magnet part housing 98b are connected to one another to form the solenoid valve 10b. The valve part 22b comprises a tappet unit 20b. The tappet unit 20b is configured to be moved by means of a magnetic field of the magnet part 12b to operate the solenoid valve 10b. The valve part 22b comprises a restoring element 32b. The restoring element 32b is configured to deflect the tappet unit 20b back into an initial state when the magnetic field of the magnet part 12b is switched off. The restoring element 32b is supported against the magnet part housing 98b. The magnet part housing 98b has a small thickness of a few millimeters. The magnet part housing 98b only slightly influences a transmission of the magnetic field from the magnet part 12b to the tappet unit 20b; particularly, a magnetic field strength at the location of the tappet unit 20b is less than 5%, preferably less than 3% and particularly preferably less than 1% less than a magnetic field strength of an identical magnet part 12b which does not comprise a magnet part housing 98b.

FIG. 6 shows an alternative solenoid valve 10c with an alternative solenoid valve device. The solenoid valve device comprises a magnet part 12c and a valve part 22c. The valve part 22c comprises a tappet unit 20c. The tappet unit 20c is configured to be moved by means of a magnetic field of the magnet part 12c to operate the solenoid valve 10c. The tappet unit 20c comprises an armature tappet 90c. The anchor tappet 90c forms the flat anchor 70c. The solenoid valve device comprises a first valve seal 64c. The tappet unit 20c comprises the first valve seal 64c. The first valve seal 64c is pressed onto the armature tappet 90c. The solenoid valve device comprises a second valve seal 128c. The tappet unit 20c comprises the second valve seal 128c. The second valve seal 128c is pressed onto the armature tappet 90c. The first valve seal 64c is spaced apart from the second valve seal 128c along an axis of movement 130c of the tappet unit 20c. The first valve seal 64a, viewed in the direction of the magnet part 12c, is arranged behind the second valve seal 128c. The first valve seal 64c is arranged between the second valve seal 128c and the magnet part 12c. The first valve seal 64c is implemented to be spatially separated from the second valve seal 128c. The first valve seal 64c and the second valve seal 128c are, apart from the armature tappet 90c, free from a common carrier element. The first valve seal 64c moves with the second valve seal 128c, and vice versa. The first valve seal 64c and the second valve seal 128c are configured to block and/or open different flow-through paths through the solenoid valve device. The valve part 22c comprises a first valve seat 50c.

The valve part 22a comprises a housing 34c. The housing 34c has a pressure port 36c. The pressure port 36c is arranged in the vicinity of the second valve seal 128c and/or a second valve seat 52c. The housing 34c has a working port 38c. The working port 38c is arranged in an intermediate region 134c between the first valve seal 64c and the second valve seal 128c. The housing 34c has a venting port 40c. The venting port 40c is arranged in the vicinity of the first valve seal 64c, the first valve seat 50c, and/or a third valve seat 132c. The first valve seal 64c is configured to be sealingly seated on the first valve seat 50c in at least one operation state. The second valve seal 128c is not seated on the first valve seat 50c in any operation state of the solenoid valve device from FIG. 6. The venting port 40c is closed when the first valve seal 64c sits sealingly on the first valve seat 50c in the implementation of FIG. 6. A flow-through path between the working port 38c and the pressure port 36c is open when the first valve seal 64c is sealingly seated on the first valve seat 50c. The valve part 22c comprises a second valve seat 52c. The second valve seal 128c is configured to be sealingly seated on the second valve seat 52c in at least one operation state. The first valve seal 64c is not seated on the second valve seat 52c in any operation state of the solenoid valve device from FIG. 6. The pressure port 36c is closed when the second valve seal 128c sits sealingly on the second valve seat 52c in the implementation of FIG. 6. A flow-Through path between the working port 38c and the venting port 40c is open when the second valve seal 128c is sealingly seated on the second valve seat 52c.

The valve part 22c comprises the third valve seat 132c. The first valve seal 64c is configured to be sealingly seated on the third valve seat 132c in at least one operation state. The second valve seal 128c is not seated on the third valve seat 132c in any operation state of the solenoid valve device from FIG. 6. A connection of at least the venting port 40c and/or at least the working port 38c to a magnet-side cavity 104c in which particularly the flat armature 70c is arranged is closed when the first valve seal 64c sits sealingly on the third valve seat 132c in the embodiment of FIG. 6. The cavity 104c is advantageously connected to the pressure port 36c and/or open to the pressure port 36c via a pressure compensation element 30c of the tappet unit 20c. A flow-through path between the working port 38c and the venting port 40c is open when the first valve seal 64c is sealingly seated on the third valve seat 132c. When the first valve seal 64c is seated on the third valve seat 132c, the first valve seat 50c is free of the first valve seal 64c, i.e., is open, and vice versa. The embodiment of FIG. 6 is free from a sliding seal, particularly a seal sliding along the tappet unit 20c. The solenoid valve device of FIG. 6 has at least substantially identical, particularly at least substantially identically arranged valve ports, i.e., the pressure port 36c, the working port 38c, and the venting port 40c. This advantageously enables or maintains the replaceability of different valve parts 22c.

### REFERENCE NUMERAL

10 solenoid valve

12 magnet part

14 magnetic coil winding

16 interior

18 magnetic core

20 tappet unit

22 valve part

24 module

26 module

28 sealing and assembly device

30 pressure compensation element

32 restoring element

34 housing

36 pressure port

38 working port

40 venting port

42 sealing arrangement

44 seal

46 seal diameter

48 effective diameter

50 first valve seat

52 second valve seat

54 connection device

56 control device

58 solenoid valve system

60 winding carrier

62 magnet yoke

64 valve seal

66 guide element

68 magnet bracket

70 flat anchor

72 sliding seal

74 layer

76 sealing ring

78 solenoid

80 magnetic circuit

82 disc-shaped end area

84 gap

86 further gap

88 effective diameter

90 armature tappet

92 coupling element

94 coupling element

96 sealing element

98 magnet part housing

100 receiving area

102 shoulder

104 cavity

106 valve chain

108 pressure line

110 surface coating

112 groove

114 method step

116 method step

118 method step

120 method step

122 method step

124 method step

126 method step

128 valve seal

130 axis of movement

132 third valve seat

134 intermediate area

1. A solenoid valve device for a pressure-compensated solenoid valve, in particular a pressure-compensating solenoid valve device, having a magnet part comprising at least one magnetic coil winding and preferably at least one magnetic core arranged at least partially in an interior of the magnetic coil winding, and having a valve part comprising at least one tappet unit, which is at least configured to control at least one flow-through path through the solenoid valve and which is at least configured to interact with a magnetic field generated within the magnet part, at least for a generation of at least one movement of the tappet unit, wherein the magnet part and the valve part form separable, independently functional modules which are in particular free of shared functional components, such as a shared magnet armature.

2. The solenoid valve device according to claim 1, wherein the valve part is at least substantially free of components at least partially engaging in the magnet part in at least one operation state.

3. The solenoid valve device according to claim 1, wherein the magnet part is at least substantially free of movably supported components and/or of components which at least partially engage in the valve part in at least one operation state.

4. The solenoid valve device according to claim 1, wherein the valve part and/or the magnet part have/has a sealing and assembly device which is configured for producing a coupling of the module formed by the valve part and the module formed by the magnet part.

5. The solenoid valve device according to claim 4, wherein at least the module, which is coupled to the valve part and formed by the magnet part, can be decoupled non-destructively from the valve part.

6. The solenoid valve device according to claim 1, wherein the tappet unit at least partially forms a flat armature.

7. The solenoid valve device according to claim 1, wherein the tappet unit comprises at least one pressure compensation element.

8. The solenoid valve device according to claim 1, wherein the tappet unit comprises at least one restoring element, which is supported against the magnet part.

9. The solenoid valve device according to claim 8, wherein the tappet unit comprises at least one pressure compensation element and wherein the restoring element is arranged at least partially within the pressure compensation element.

10. The solenoid valve device according to claim 1, wherein the magnet part and the valve part are at least substantially thermally decoupled from one another.

11. The solenoid valve device according to claim 1, wherein the valve part comprises at least one housing with at least one pressure port, at least one working port, and/or at least one venting port, wherein the pressure port is sealed against the working port and/or the venting port at least by means of a sealing arrangement.

12. The solenoid valve device according to claim 11, wherein at least one seal of the sealing arrangement has a sealing diameter which at least substantially corresponds to an effective diameter of at least one valve seat of the valve part.

13. The solenoid valve device according to claim 1, wherein the sealing arrangement includes at least one sliding seal.

14. The solenoid valve device according to claim 13, wherein the sliding seal includes a sealing ring, which is at least largely formed from an elastomer, wherein the elastomer comprises a thin layer of polytetrafluoroethylene.

15. The solenoid valve device according to claim 1, wherein at least the magnet part is hermetically enclosed by injection-molding.

16. The solenoid valve device according to claim 1, wherein the tappet unit comprises at least one first valve seal and at least one second valve seal, which is in particular spaced apart from the first valve seal along an axis of movement of the tappet unit, wherein the valve seals are configured to block and/or open respectively different flow-through paths through the solenoid valve.

17. A pressure-compensated solenoid valve with a solenoid valve device according to claim 1, further comprising an implementation as a 3/2 NO valve, as a 3/2 NC valve, as a 2/2 NO valve, or as a 2/2 NC valve.

18. A solenoid valve system with a solenoid valve device according to claim 1, having a plurality of at least partially differently implemented magnet parts which can interchangeably be coupled to the valve part and are implemented as a separable module, and/or with a plurality of valve parts which are at least partially implemented differently from one another, can interchangeably be coupled with the magnet part and are implemented as a separable module.

19. A magnet part of the solenoid valve device according to claim 1.

20. A valve part of the solenoid valve device according to claim 1.

21. A method with a solenoid valve device for a pressure-compensated solenoid valve with a pressure-compensating solenoid valve device according claim 1.
